(19) United States
(12) Patent Application Publication
(10) Pub. No.: US 2009/0262391 A1
(43) Pub. Date: Oct. 22, 2009

(54) Image processing apparatus

(75) Inventor: Hideo SUTO, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/382,795

(22) Filed: Mar. 24, 2009

(30) Foreign Application Priority Data
Apr. 22, 2008 (JP) 2008-110908

(51) Int. Cl. G06F 3/12

(52) U.S. Cl. 358/1.15

(57) ABSTRACT

An image processing apparatus obtains a job identification condition from a host device. When the image processing apparatus receives an input job, it also obtains a primary processing condition, uses the primary processing condition and the job identification condition to determine whether the job was input under a given condition, and if so, notifies the host device. In reply, the host device sends the image processing apparatus a secondary processing condition, and the image processing apparatus executes the input job according to both the primary and the secondary processing conditions. An administrator at the host device can use this capability to supervise and manage the use of the image processing device by other users.

### BACKGROUND OF THE INVENTION

1. Field of the Invention

The present invention relates to an image processing apparatus that performs job control.

2. Description of the Related Art

Conventional image processing apparatus, such as a printer or a multi-function peripheral (MFP), executes different job processing depending on instructions input by a user or received from an information processing device or other host device. For example, the image processing apparatus may execute a printing job by printing images on recording media according to print data received from the host device and execute a facsimile transmission job by scanning a document supplied by a user and transmitting the scanned image to a distant device.

In general, as described in Japanese Patent Application Publication No. 2002-321406, the image processing apparatus switches its mode of operation from one job to the next according to commands included in the processing instructions input with the job, or according to the port via which the job is received.

The processing to be executed by conventional image processing apparatus is thus determined when the job is received from the user or from the host device and cannot be changed. This is sometimes problematic. The user or a system administrator may want to alter the job instructions or add further instructions.

### SUMMARY OF THE INVENTION

An object of the present invention is to provide an image processing apparatus that permits further processing to be added to a job after input of the job by a user or from a host device.

According to the present invention, an image processing apparatus obtains a job identification condition or set of conditions from a host device. When the image processing apparatus receives an input job, it also obtains a primary processing condition or set of conditions indicating how the input job is to be executed. The image processing apparatus uses the primary processing conditions and the job identification conditions to determine whether the job was input under given conditions, and notifies the host device if the input job was input under the given conditions. In reply, the host device sends the image processing apparatus a secondary processing condition or set of conditions, and the image processing apparatus executes the input job according to both the primary and the secondary processing conditions.

A person operating the host device can accordingly modify the processing performed when the image processing apparatus receives a specified type of input job, a job input from a specified source, or an input job received under other specified conditions. The modification may take the form of reporting details of the input job as given in the primary processing conditions, canceling or temporarily suspending execution of the job, adding a type of output not specified in the primary processing conditions, or adding output to a destination not specified in the primary processing conditions.

These capabilities are particularly useful when the image processing apparatus is connected to a network and receives jobs from various sources, since it enables the operation of the image processing apparatus to be supervised by an administrator at the host device.

### BRIEF DESCRIPTION OF THE DRAWINGS

In the attached drawings:

FIG. 1 is a drawing illustrating a network configuration;

FIG. 2A is a table of input information and related information;

FIG. 2B is a table of conditions;

FIG. 3 is a block diagram illustrating the internal structure of a multifunction peripheral apparatus in a first embodiment of the invention;

FIG. 4 illustrates the format in which conditions and destination data are stored;

FIG. 5 illustrates an information transmission sequence involving the two host devices and the multifunction peripheral apparatus in FIG. 1;

FIG. 6 illustrates an information transmission sequence involving the multifunction peripheral apparatus, the control panel, and one host device in FIG. 1;

FIG. 7 is a flowchart illustrating a condition setting process;

FIG. 8 is a flowchart illustrating a procedure from job input to notification in the first embodiment;

FIG. 9 is a flowchart illustrating the notification process;

FIG. 10 is a flowchart illustrating the processing of a command sent from a host device;

FIG. 11 is a block diagram showing the internal structure of the multifunction peripheral apparatus in a second embodiment; and

FIG. 12 is a flowchart illustrating a procedure from job input to notification in the second embodiment.

### DETAILED DESCRIPTION OF THE INVENTION

Embodiments of the invention will now be described with reference to the attached drawings, in which like elements are indicated by like reference characters. Facsimile is abbreviated to ‘fax’ in the drawings.

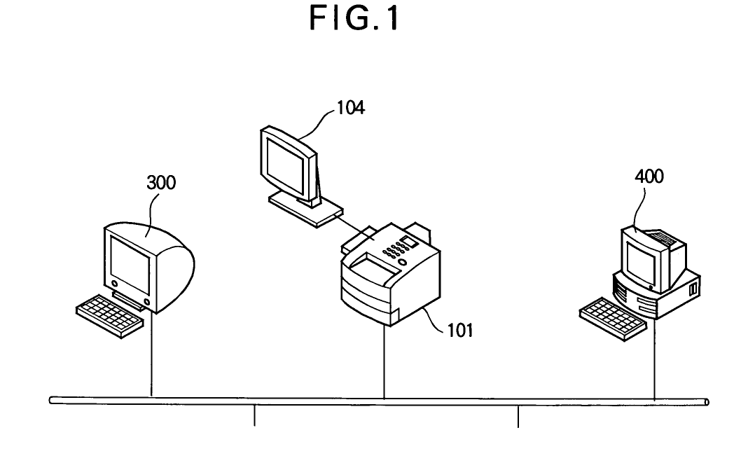

The exemplary image processing apparatus in the following description is a multifunction peripheral apparatus 101 having a scanning function for scanning images, a printing function for printing images on recording media, a facsimile function for transmitting images by facsimile, and an e-mail function for transmitting images by electronic mail. As shown in FIG. 1, the multifunction peripheral apparatus 101 is connected by a communication network to other information processing units, such as host devices 300 and 400. Host device 300 is operated by a general user, for example, to generate printing data and facsimile data and send the data as jobs to the multifunction peripheral apparatus 101. Host device 400 is operated by an administrator, for example, who manages the multifunction peripheral apparatus 101 by sending job identification conditions and secondary processing conditions. The multifunction peripheral apparatus 101 also has a control panel 104, described below, through which a user can enter jobs to be executed by the multifunction peripheral apparatus 101. The jobs that may be entered through the control panel 104 include copy jobs using the scanning and printing functions, facsimile transmission jobs using the scanning and facsimile functions, and e-mail transmission jobs using the scanning and e-mail functions. When a job is entered through the control panel 104, the multifunction peripheral apparatus 101 adds job input information as primary processing conditions.

The job input information assigned by the multifunction peripheral apparatus 101 and the job identification conditions and secondary processing conditions issued from host device 400 will now be described in more detail.

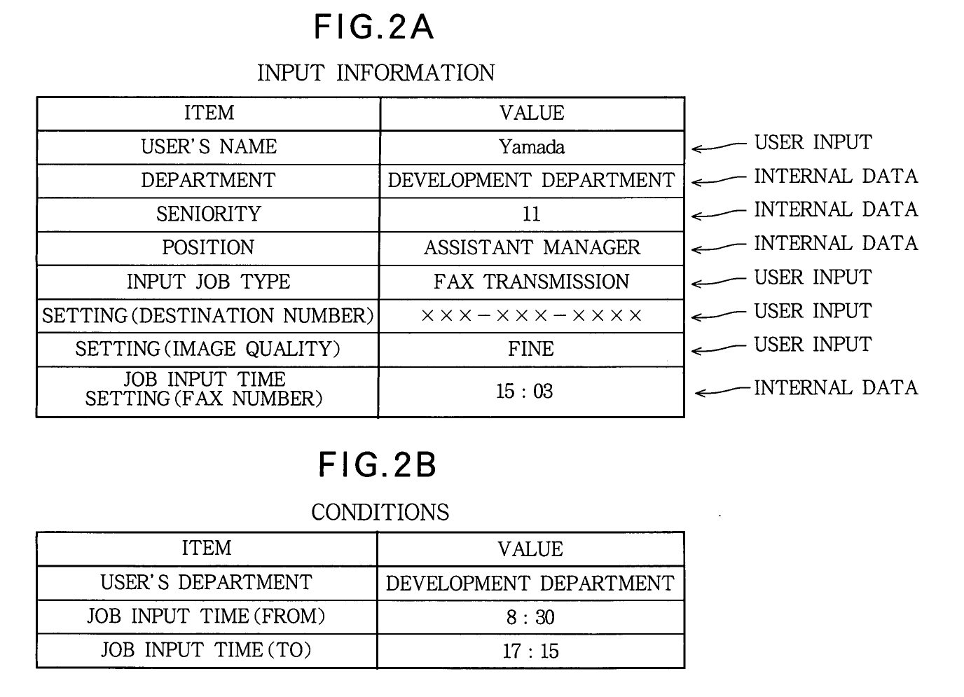

Job input information is assigned each time a job is input by the user. A user who inputs a job to the multifunction peripheral apparatus 101 generally specifies a user name, a password, an input job type, and settings that depend on the type of job. The multifunction peripheral apparatus 101 checks the input values to determine whether the job is input by an authorized user. If the job is input from an authorized user, information pertaining to the user will already have been stored in the multifunction peripheral apparatus 101. From this stored information, the multifunction peripheral apparatus 101 extracts the information necessary for the job and assigns it to the job as job input information. The assigned information may include, for example, the user's department, seniority, and position. If the multifunction peripheral apparatus 101 incorporates a real-time clock or supports a network protocol for acquiring time from a time server, the multifunction peripheral apparatus 101 adds the job input time to the job input information. FIG. 2A shows exemplary job input information including the user's name, department, seniority, and position, the input job type, associated settings, and the job input time. The job input type indicates the type of the job that the user wants the multifunction peripheral apparatus 101 to do, such as copying, printing, facsimile transmission, or e-mail transmission. The job input information shown in FIG. 2A specifies facsimile transmission. When a facsimile transmission job is specified, the destination facsimile (fax) number, image quality, and other information are specified as necessary in the settings.

Job identification conditions are specified to select input jobs to which secondary processing conditions may be added by the administrator. The job identification conditions described below are specified in a key-and-value format, but other formats may be used as appropriate. If the job identification conditions specified by the administrator include ‘Development Department’ as the user's department, ‘8:30’ as the job input time (from), and ‘17:15’ as the job input time (to), a job input at any time from 8:30 to 17:15 by any user in the Development Department satisfies the job identification conditions. The multifunction peripheral apparatus 101 determines jobs to which secondary processing conditions may be applied by comparing the job input information as shown in FIG. 2A with the job identification conditions as shown in FIG. 2B.

The secondary processing conditions specify processing to be executed by the multifunction peripheral apparatus 101 for jobs satisfying the job identification conditions. The administrator specifies secondary processing conditions through host device 400. Secondary processing conditions that may be specified include canceling a job, suspending a job, resuming a job, obtaining a job log, obtaining job input information, performing additional printing, performing additional facsimile transmission, and performing additional e-mail transmission. These secondary processing conditions are sent to the multifunction peripheral apparatus 101 in a predetermined command format.

Secondary processing conditions may be specified manually by the administrator, or by an application program set up by the administrator to reply automatically to notifications received from the multifunction peripheral apparatus.

### First Embodiment

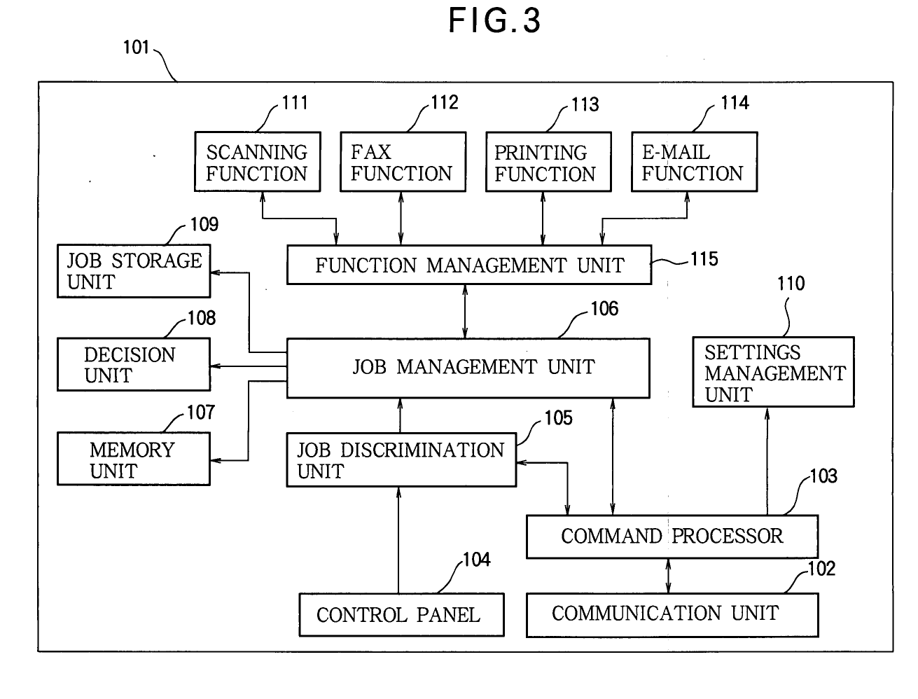

The internal structure of the multifunction peripheral apparatus 101 in a first embodiment of the invention will be described with reference to the block diagram shown in FIG. 3. The multifunction peripheral apparatus 101 includes a communication unit 102, a command processor 103, the control panel 104, a job discrimination unit 105, a job management unit 106, a memory unit 107, a decision unit 108, a job storage unit 109, a settings management unit 110, a scanning functional unit 111, a facsimile (fax) functional unit 112, a printing functional unit 113, an e-mail functional unit 114, and a function management unit 115. For brevity, the functional units 111-114 are denoted ‘functions’ in the drawings and the description below.

The communication unit 102 holds information describing a communication protocol and communicates with external devices such as the host devices 300, 400, in accordance with the protocol and with instructions given by the command processor 103. The processing executed by the communication unit 102 includes local communication processing via a local bus such as a universal serial bus (USB) or an IEEE 1394 serial bus, and global communication processing through a network. The communication unit 102 outputs information received from the external devices to the command processor 103 and sends information input through the command processor 103 to external devices.

IEEE is an abbreviation of ‘Institute of Electrical and Electronics Engineers’. The IEEE 1394 serial bus is also known under trade names such as FireWire, i.LINK, and Lynx.

The command processor 103 is situated above the communication unit 102 in the processing hierarchy. Besides processing information received through the communication unit 102, the command processor 103 issues requests to send information generated in such processing, or information output from the job discrimination unit 105 and memory unit 107, which are still higher in the processing hierarchy. An information transmission request is made by creating a transmission command and sending the transmission command to the communication unit 102. The command processor 103 responds to a variety of requests from host devices. If a host device makes a request to change a setting, the command processor 103 passes the desired setting information to the settings management unit 110 and has the settings management unit 110 change the setting. If a host device makes a request pertaining to a job, the command processor 103 has the job management unit 106 execute the relevant processing.

The control panel 104 is an input-output device connected to the multifunction peripheral apparatus 101 by an internal bus interface. The control panel 104 may use a display panel such as a liquid crystal display (LCD) panel as an output device and a touch panel or the like overlaid on the display panel as an input device, enabling the control panel 104 to display the status of the multifunction peripheral apparatus 101 and receive input from users. Information received through the control panel 104 is output to the job discrimination unit 105.

The job discrimination unit 105 identifies the job that should be executed, in accordance with the information input through the command processor 103 or control panel 104, and assigns job input information. The job discrimination unit 105 outputs the identified job and the job input information to the job management unit 106.

The job management unit 106 acts on the information received from the job discrimination unit 105 by issuing appropriate job instructions to the function management unit 115, monitors the subsequent progress of the job, and decides when the job has ended. The job management unit 106 also responds to instructions pertaining to the job and inquiries about job progress and the like from the user. In addition, if any job identification conditions specified by the administrator are stored in the memory unit 107, then before issuing instructions to the function management unit 115, the job management unit 106 temporarily halts job processing, saves the job in the job storage unit 109, and instructs the decision unit 108 to compare the job identification conditions with the job input information. Processing of the temporarily halted job resumes when commands allowing the job processing to resume have been received from all the destinations specified in the matching job identification conditions, or when the decision unit 108 determines that none of the stored job identification conditions match the job input information.

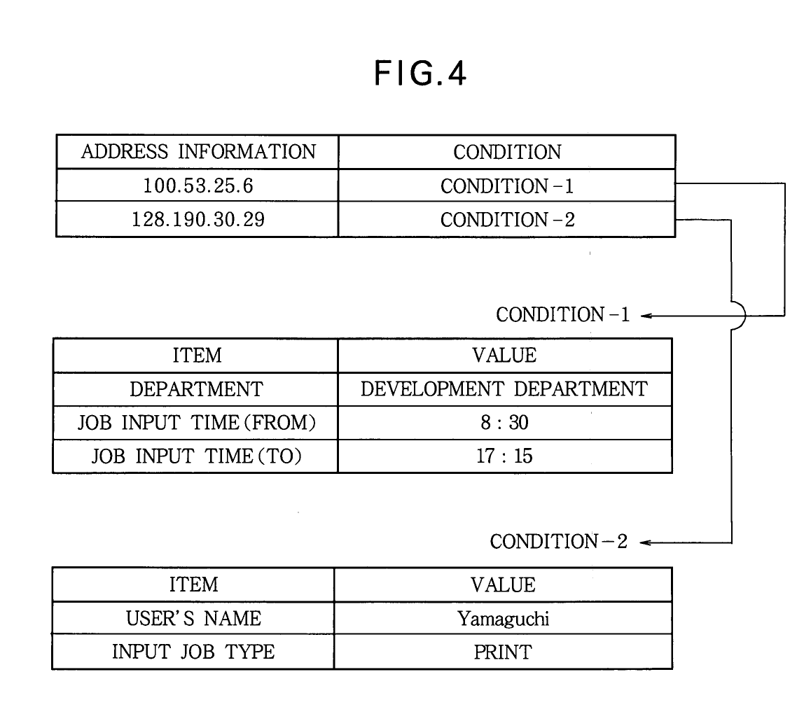

The memory unit 107 stores job identification conditions sent from host device 400 in association with the source of the job identification conditions, which may be host device 400 itself, another host device, or an application program running on the host device. If the network address of host device 400 is 100.53.25.6, for example, memory unit 107 may store a set of job identification conditions referred to below as ‘condition-1’ in association with network address 100.53.25.6 as shown in FIG. 4. If a job input by a user satisfies condition-1, this fact can then be reported to host device 400.

At the request of the job management unit 106, the decision unit 108 compares job identification conditions that have been sent from host device 400 and stored in the memory unit 107 with the job input information assigned to jobs input by users and decides which jobs may have secondary processing conditions applied.

The job storage unit 109 saves jobs halted by the job management unit 106.

The settings management unit 110 receives requests to read or change settings of the multifunction peripheral apparatus 101, and manages the settings.

The scanning function 111 drives a scanner unit (not shown) that scans documents. The scanning function 111 is specialized for this operation and does not by itself initiate changes in later operations.

The facsimile function 112 controls facsimile transmission and reception. The facsimile function 112 saves received images in locations specified by the job management unit 106 or transfers the images to specified locations, and sends these images or images scanned by the scanning function 111 as facsimile data. The facsimile function 112 is specialized for these operations and does not by itself initiate changes in later operations.

The printing function 113 controls printing and prints images specified by the job management unit 106. The printing function 113 is specialized for this operation and does not by itself initiate changes in later operations.

The e-mail function 114 controls the transmission and reception of e-mail. The e-mail function 114 saves received images in locations specified by the job management unit 106 or transfers the images to the specified locations, and transmits images scanned by the scanning function 111 by e-mail. The e-mail function 114 is specialized for these operations and does not by itself initiate changes in later operations.

The function management unit 115 manages the scanning function 111, facsimile function 112, printing function 113, and e-mail function 114 of the multifunction peripheral apparatus 101. The function management unit 115 assigns the functions to be executed for each job in accordance with instructions received from the job management unit 106.

The communication unit 102, command processor 103, job discrimination unit 105, job management unit 106, decision unit 108, and settings management unit 110 are incorporated into the multifunction peripheral apparatus 101 as software. The software programs may be stored in a volatile memory in the multifunction peripheral apparatus 101, in a non-volatile read-only memory (ROM), in a non-volatile rewritable memory such as a flash memory, or on a magnetic medium such as a hard disk. Each function is implemented by execution of the corresponding program on a central processing unit (CPU, not shown) in the multifunction peripheral apparatus 101.

The memory unit 107 and job storage unit 109 may be implemented as volatile memory or non-volatile rewritable memory such as a flash memory, or on a magnetic medium such as a hard disk.

The communication unit 102, command processor 103, control panel 104, job discrimination unit 105, and job management unit 106 operate as a first input processor that obtains primary processing conditions.

The communication unit 102, command processor 103, and job management unit 106 operate as a second input processor that obtains job identification conditions from the host device.

The communication unit 102, command processor 103, and job management unit 106 also operate as a notifier that notifies a host device if the input job was input under a given condition.

In addition, the communication unit 102, command processor 103, and job management unit 106 operate as a third input processor that obtains secondary processing conditions from host device in reply to the notification.

The scanning functional unit 111, facsimile functional unit 112, printing functional unit 113, e-mail functional unit 114, and function management unit 115 operate as an execution controller that executes the input job according to the primary and secondary processing conditions.

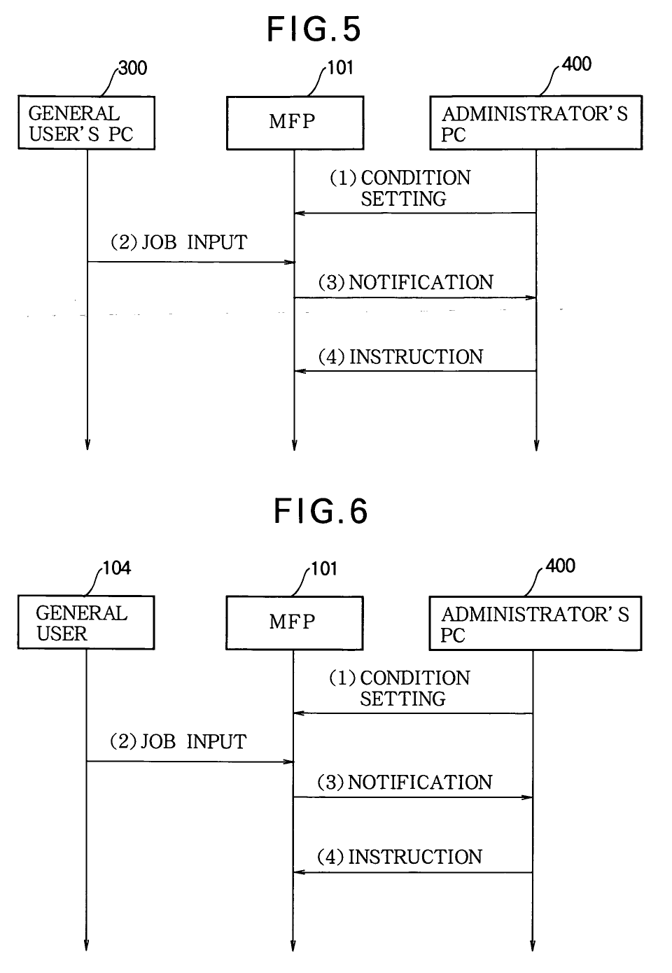

The operation of the first embodiment will now be described. The transfer of jobs, commands, and other information between the multifunction peripheral apparatus 101 and host devices 300 and 400 will be described first with reference to FIGS. 5 and 6. The steps executed by the multifunction peripheral apparatus 101 will be described later in detail.

FIG. 5 shows an information transmission-reception sequence among the multifunction peripheral apparatus 101, host device 300, and host device 400. The downward-pointing arrows represent the flow of time. The administrator who manages the multifunction peripheral apparatus 101 first specifies job identification conditions by using host device 400 ((1) condition setting). The job identification conditions specified in this step select jobs to which secondary processing conditions may be applied by the administrator. In the following description, it will be assumed that the administrator specifies the following job identification conditions: ‘Development Department’ as the user's department, ‘8:30’ as the job input time (from), and ‘17:15’ as job input time (to). The job identification conditions specified by the administrator at host device 400 are sent to the multifunction peripheral apparatus 101 in a condition setting command.

Later, a general user sends a job from host device 300 to the multifunction peripheral apparatus 101. When the job is received ((2) job input), the multifunction peripheral apparatus 101 assigns job input information to the received job. The job input information assigned in this embodiment includes the user's name, department, seniority, and position, the job input time, and primary processing conditions such as the job type and settings.

When the job input information has been assigned, the multifunction peripheral apparatus 101 temporarily halts the job processing and compares the job input information with the above job identification conditions. If the received job is input by a user in the Development Department at a time between 8:30 to 17:15, the multifunction peripheral apparatus 101 decides that the job satisfies the job identification conditions and notifies the host device 400 that sent the condition setting command ((3) notification).

Host device 400 now sends one or more secondary processing conditions to the multifunction peripheral apparatus 101 in one or more instruction commands ((4) instruction). As noted above, secondary processing conditions for canceling a job, suspending a job, resuming a job, obtaining a job log, obtaining the job input information, and performing additional printing, additional facsimile transmission, and additional e-mail transmission are available. In the first embodiment, suspending a job includes leaving the job in its temporarily halted state.

In the multifunction peripheral apparatus 101, the command processor 103 sends the instruction command(s) to the job management unit 106 with an operation start command instructing it to resume the processing of the temporarily halted job. When this operation start command is received, the job management unit 106 resumes the processing of the job by doing whatever is called for by the specified secondary processing conditions. When the processing of the secondary processing conditions ends, or if there are no secondary processing conditions, host device 400 sends a ‘job-through’ command to the multifunction peripheral apparatus 101. Upon receiving the job-through command, the multifunction peripheral apparatus 101 resumes the processing called for by the primary processing conditions, and terminates the job when this processing ends.

If host device 300 submits a facsimile transmission job, including the image data to be transmitted, and if host device 400 sends a secondary processing condition for additional e-mail transmission, for example, then when the operation start command is received, the multifunction peripheral apparatus 101 sends host device 400 the submitted image data as an attachment to e-mail. When the e-mail transmission is completed, host device 400 sends a job-through command to the multifunction peripheral apparatus 101, and the multifunction peripheral apparatus 101 now transmits the same image in facsimile form to the destination specified by host device 300 in the job input information. The job processing ends when the facsimile transmission ends.

FIG. 6 shows another information transmission-reception sequence between the multifunction peripheral apparatus 101 and host device 400, in which the control panel 104 of the multifunction peripheral apparatus 101 is used as the job entry port. The downward-pointing arrows again represent the flow of time. As in FIG. 5, the administrator who manages the multifunction peripheral apparatus 101 first uses host device 400 to specify job identification conditions ((1) condition setting) that select jobs to which secondary processing conditions may be applied. It will again be assumed that the administrator specifies ‘Development Department’ as the user's department, ‘8:30’ as the job input time (from), and ‘17:15’ as job input time (to). These job identification conditions are sent to the multifunction peripheral apparatus 101 in a condition setting command from host device 400.

Later, a general user inputs a job to the multifunction peripheral apparatus 101 through the control panel 104. When the job is received ((2) job input), the multifunction peripheral apparatus 101 assigns job input information as described above, including the user's name, department, seniority, and position, the job input time, and primary processing conditions such as the job type and settings.

When the job input information has been assigned, the multifunction peripheral apparatus 101 temporarily halts the job processing and compares the job input information with the above job identification conditions. If the received job was input by a user in the Development Department at a time between 8:30 to 17:15, the multifunction peripheral apparatus 101 decides that the job satisfies the job identification conditions and notifies the host device 400 that sent the condition setting command ((3) notification).

Host device 400 now sends one or more secondary processing conditions to the multifunction peripheral apparatus 101 in one or more instruction commands ((4) instruction), selecting from among secondary processing conditions for canceling a job, suspending a job, resuming a job, obtaining a job log, obtaining the job input information, additional printing, additional facsimile transmission, and additional e-mail transmission, as above. The command processor 103 in the multifunction peripheral apparatus 101 sends the job management unit 106 the secondary processing conditions and an operation start command, causing the job management unit 106 to resume the processing of the temporarily halted job and execute further processing, first in accordance with the secondary processing conditions, then in accordance with the primary processing conditions.

If a facsimile transmission job is input through the control panel 104 by a user who places the document to be transmitted in the multifunction peripheral apparatus 101, for example, and if host device 400 again sends a secondary processing condition for additional e-mail transmission, then when the operation start command is received, the scanning function 111 starts scanning the document, and the multifunction peripheral apparatus 101 sends host device 400 the scanned image as an attachment to e-mail. When the e-mail transmission has been completed and a job-through command has been received from host device 400, the multifunction peripheral apparatus 101 transmits the scanned image by facsimile to the destination specified by the user, and terminates the job processing when the facsimile transmission ends.

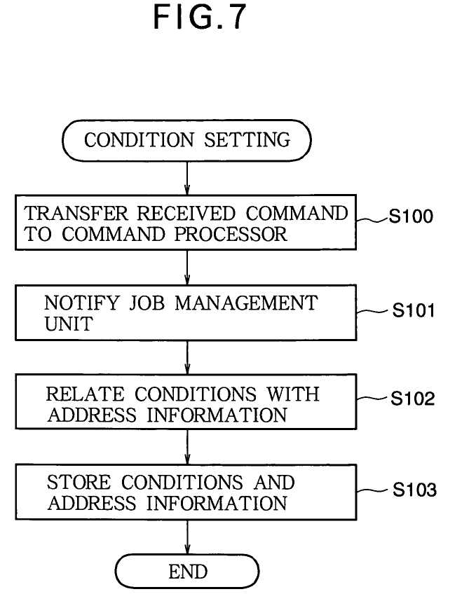

The processing steps executed by the multifunction peripheral apparatus 101 will now be described with reference to the flowcharts in FIGS. 7 to 10.

FIG. 7 illustrates the setting of job identification conditions. In the multifunction peripheral apparatus 101, the communication unit 102 receives a command from host device 400. If the command is received through a network, the communication unit 102 can identify the command as coming from a higher hierarchical level by a special code provided in a predetermined location in the received packet. If the command is received through a local universal serial bus (USB), the communication unit 102 can identify the command as coming from a higher hierarchical level by the logical channel through which the command is received, or the end point of the logical channel. The communication unit 102 transfers the identified higher-level command to the command processor 103 (step S100).

In step S101, the command processor 103 analyzes the command. If the purpose of the command is to set job identification conditions, the command processor 103 extracts the job identification conditions from the command, extracts address information indicating where to send notification when an input job satisfies the job identification conditions, and notifies the job management unit 106 (step S101).

When notified by the command processor 103, the job management unit 106 relates the job identification conditions with the address information and transfers the job identification conditions and the address information to the memory unit 107 (step S102).

The memory unit 107 stores the job identification conditions and the address information transferred from the job management unit 106, maintaining the relationship between them (step S103).

Although FIG. 7 shows only a single set of job identification conditions being stored in the memory unit 107, the memory unit 107 can store multiple sets of job identification conditions for different host devices, as illustrated in FIG. 4. When a new set of job identification conditions is obtained, they may be added to the existing set of job identification conditions stored in the memory unit 107, or the existing set of job identification conditions stored in the memory unit 107 may be modified for consistency with the new set of job identification conditions, or the existing set of job identification conditions may simply be replaced with the new set of job identification conditions.

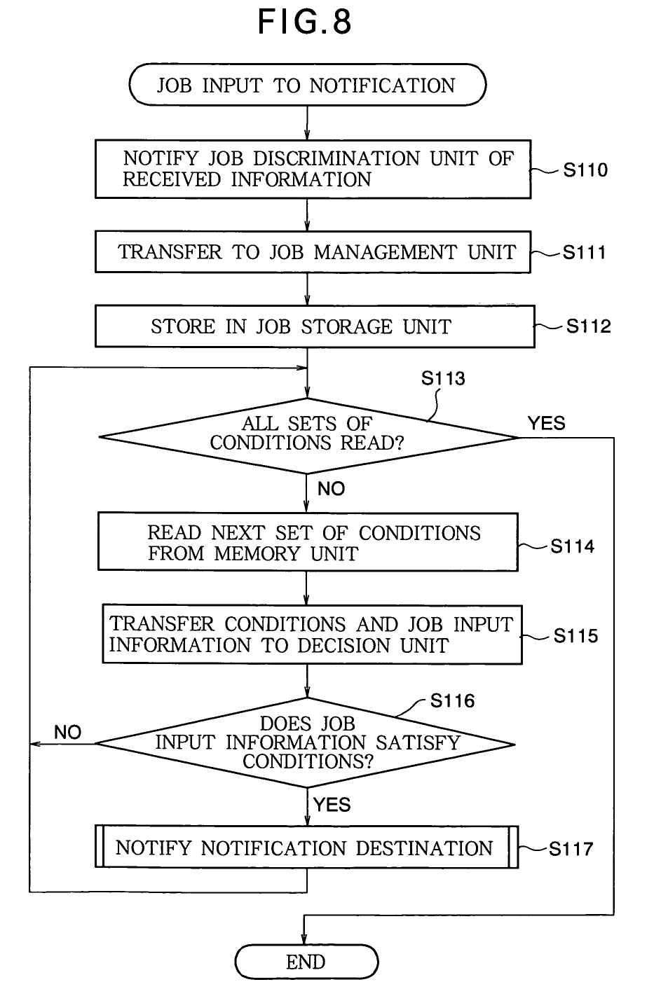

The process from job input to notification will be described with reference to the flowchart in FIG. 8. It will be assumed that the job is input to the multifunction peripheral apparatus 101 through the control panel 104 by a user who selects a job identifier (ID) from a list of job identifiers displayed as a job menu on the control panel 104.

In step S110, the control panel 104 reports the user-selected job menu information or ID to the job discrimination unit 105.

The job discrimination unit 105 identifies the type of job to be executed from the job menu ID, assigns job input information, and transfers the identified job and the job input information to the job management unit 106 (step S111).

The job management unit 106 saves the job in the job storage unit 109. The job storage unit 109 is preferably a non-volatile storage unit, so that if a temporary power failure occurs, job processing can continue after power is restored. The job input information is retained in the job management unit 106 (step S112).

The job management unit 106 now checks whether all sets of job identification conditions stored in the memory unit 107 have been read (step S113). If so, the process in FIG. 8 ends.

If all sets of job identification conditions have not been read, the job management unit 106 reads the next set of job identification conditions stored in the memory unit 107 (step S114).

The job management unit 106 transfers the job identification conditions read in step S114 and the job input information assigned in step S111 to the decision unit 108 and instructs the decision unit 108 to compare the job identification conditions with the job input information (step S115).

The decision unit 108 compares the job identification conditions with the job input information (step S116). If the specified job identification conditions are satisfied (Yes in step S116), input of the job is reported to the address related to the job identification conditions (step S117). If the specified job identification conditions are not satisfied (No in step S116), the process returns to step S113.

The loop from step S113 to step S116 continues until the job has been reported to all notification destinations with job identification conditions matched by the job input information.

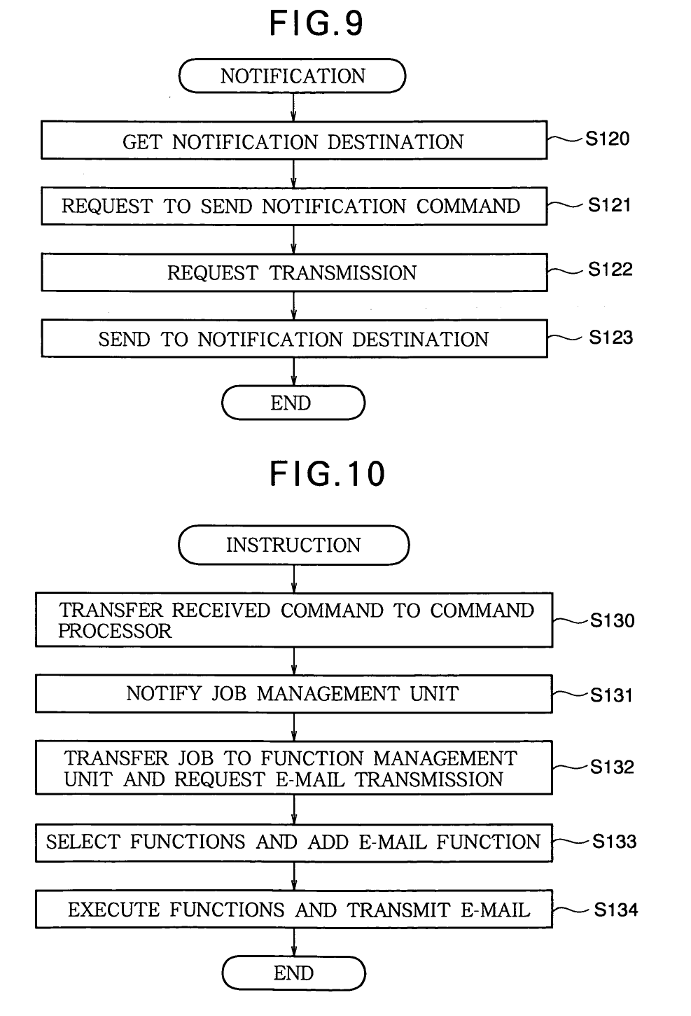

The notification process is illustrated in FIG. 9. First, the job management unit 106 fetches the address information related to the job identification conditions matching the input job from the memory unit 107 (step S120).

The job management unit 106 creates information indicating that the input job satisfies the job identification conditions and requests the command processor 103 to send a notification command (step S121).

The command processor 103 issues a transmission request to the communication unit 102 by transferring the address information together with a notification command created in accordance with information indicating that the input job satisfies the job identification conditions (step S122).

The communication unit 102 extracts the destination address from the address information and sends the notification command to the extracted address (step S123).

The execution of secondary processing conditions will be described with reference to the flowchart in FIG. 10. As noted above, the secondary processing conditions may cancel the job, suspend the job, resume the job, obtain a job log, obtain the job input information, or specify additional facsimile transmission, additional e-mail transmission, or additional printing. In the following description, the instruction specifies additional e-mail transmission.

When it is reported that the job input to the multifunction peripheral apparatus 101 satisfies the job identification conditions, host device 400 instructs the multifunction peripheral apparatus 101 to add e-mail transmission to the job processing conditions. This instruction may be given by a single command or by a sequence of commands. For example, the host device 400 may send a job identifying command that specifies the job to which the secondary processing conditions should be applied, then an additional e-mail transmission command that requests additional e-mail transmission, and then an execution start command that starts the actual processing. After receiving the e-mail transmission, host device 400 may send further commands, such as the ‘job-through’ command noted above, or a command including further secondary processing conditions.

In step S130, the communication unit 102 transfers the command or commands specifying the job and requesting e-mail transmission to the command processor 103.

The command processor 103 notifies the job management unit 106 that an additional e-mail transmission command has been received from the host device (step S131).

The job management unit 106 reads the specified job from the job storage unit 109, transfers the job to the function management unit 115, and requests additional e-mail transmission (step S132).

In step S133, the function management unit 115 assigns the functions to be executed as part of the job read from the job storage unit 109. For a facsimile scanning and transmission job, for instance, the function management unit 115 reserves the scanning function 111 and facsimile function 112, and notifies the two functions of the location in which the scanned data should be written and from which the scanned data may be read. The function management unit 115 then sends the scanning function 111 specific settings that select the scanning quality and select color or monochrome scanning, and sends the facsimile function 112 settings such as the destination facsimile number. Next, the function management unit 115 reserves the e-mail function 114, specifies the location from which the scanned data may be read, and specifies other settings such as the destination e-mail address. These reservations are made before any of the functions are actually executed, so that the additional e-mail transmission instruction given by host device 400 can be executed together with the input facsimile transmission job by scanning the document only once.

When the execution start command is given, the function management unit 115 activates the above functions in the appropriate sequence. The scanning function 111 scans the document, and the e-mail function 114 sends e-mail with scanned image data attached (step S134). In the first embodiment, the facsimile transmission function is activated after the e-mail transmission, as explained above.

The first embodiment enables additional operations to be executed in association with jobs input from a host device or directly through the control panel of the multifunction peripheral apparatus. In an enterprise environment, a system administrator can use this capability to supervise the multifunction peripheral apparatus and make sure that it is not used for undesirable or frivolous purposes. The system administrator can use the capability to add additional operations for the dissemination of information, for centralized record-keeping, or for various other useful purposes.

### Second Embodiment

Although temporarily halting each input job as in the first embodiment is advantageous from the standpoint of security, it also delays the completion of the job, and space in the job storage unit 109 is required for saving the temporarily halted job. In the second embodiment, input jobs are processed directly without being temporarily halted, thereby saving time and storage space.

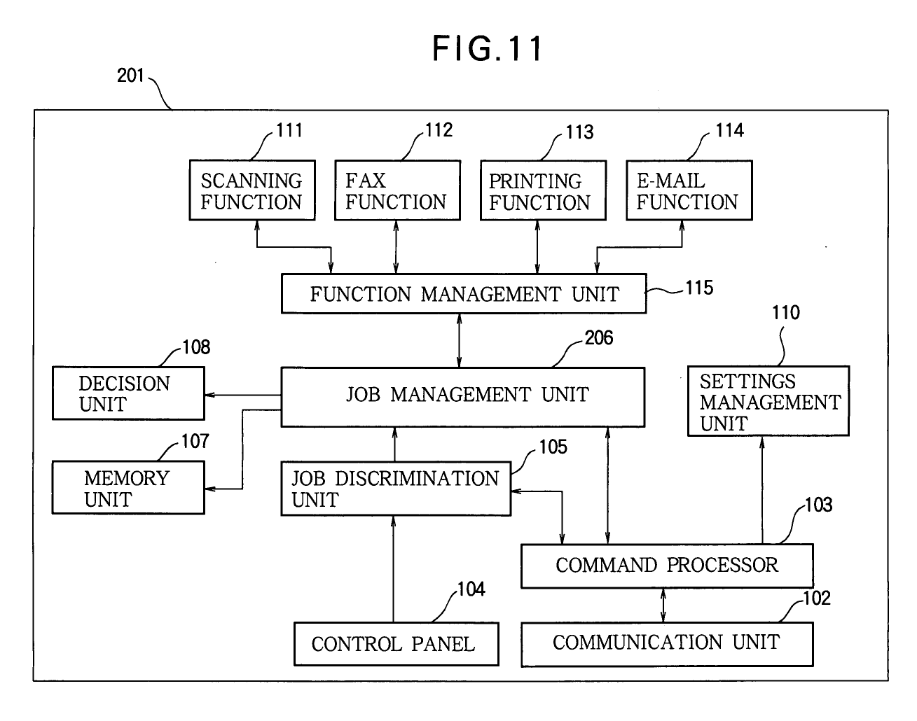

Referring to FIG. 11, the multifunction peripheral apparatus 201 in the second embodiment differs from the multifunction peripheral apparatus 101 in the first embodiment in having a different job management unit 206.

As in the first embodiment, the job management unit 206 monitors the progress and status of jobs input by users, decides when each job has ended, and responds to inquiries and instructions pertaining to jobs. Differing from the first embodiment, even if job identification conditions specified by an administrator are stored in the memory unit 107, the job management unit 206 in the second embodiment transfers each input job to the function management unit 115 without temporarily halting job processing.

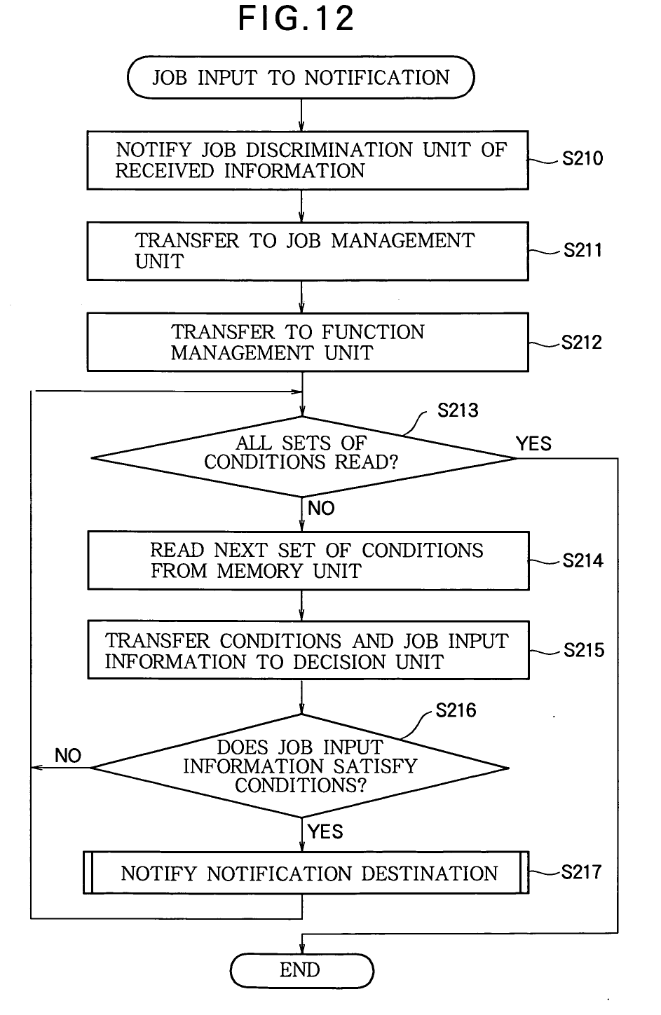

The processing executed by the multifunction peripheral apparatus 201 will now be described. The process from job input up to notification will be described with reference to the flowchart in FIG. 12. Descriptions of the setting of job identification conditions, the notification process, and the processing of secondary processing conditions will be omitted because these processes can be executed as described in the first embodiment.

As in the first embodiment, jobs may be input either from host device 300 or through the control panel 104. In the description below, a job is input to the multifunction peripheral apparatus 201 through the control panel 104 by a user who selects a job identifier (ID) from a list of job identifiers displayed as a job menu on the control panel 104.

In step S210 in FIG. 12, the control panel 104 reports the user-selected job menu information or ID to the job discrimination unit 105.

When the job to be executed has been identified from the job menu ID, the job discrimination unit 105 assigns job input information and transfers the identified job and the job input information, including the primary processing conditions, to the job management unit 206 (step S211).

The job management unit 206 retains the job input information but transfers the job to the function management unit 115 with appropriate instructions to begin execution of the job according to the primary processing conditions (step S212).

The job management unit 206 checks whether all sets of job identification conditions stored in the memory unit 107 have been read (step S213). If so, the process in FIG. 12 ends.

If all sets of job identification conditions have not been read, the job management unit 206 reads the next set of job identification conditions stored in the memory unit 107 (step S214).

The job management unit 206 transfers the job identification conditions read in step S214 and the job input information assigned in step S211 to the decision unit 108 and instructs the decision unit 108 to compare the job identification conditions with the job input information (step S215).

The decision unit 108 compares the job identification conditions with the job input information (step 216). If the job identification conditions are satisfied (Yes in step S216), input of the job is reported to the address related to the job identification conditions (step S217). If the job identification conditions are not satisfied (No in step S216), the process returns to step S213.

The loop from step S213 to step S216 continues until the job has been reported to all notification destinations with job identification conditions matched by the job input information. In the meantime, the function management unit 115 proceeds to reserve the functions necessary to execute the primary processing conditions, and then to activate the reserved functions.

While the primary processing conditions are being executed, secondary processing conditions may be received in reply to notifications issued in step S217. The job management unit 206 then issues further instructions to the function management unit 115, which reserves and actives further functions as necessary to execute the secondary processing conditions.

Compared with the first embodiment, input jobs are processed faster in the second embodiment because job processing is not temporarily halted.

In the second embodiment, secondary processing conditions will in general be executed after the primary processing conditions, but in some cases (e.g., suspension or cancellation) the secondary processing conditions may supersede the primary processing conditions, and in other cases processing of both conditions may proceed concurrently (e.g., primary printing and secondary e-mail transmission).

In a variation of both the first and second embodiments, the secondary processing conditions may be stored in advance in the multifunction peripheral apparatus, together with job identification conditions, so that the execution of the secondary processing conditions can begin without waiting for the host device to reply to the notification from the information processing apparatus. That is, the host device is able to reply in advance of the notification.

The invention is not limited to a multifunction peripheral apparatus of the type described above. The invention can also be practiced in other types of image processing apparatus such as printers and facsimile machines.

Those skilled in the art will recognize that further variations are possible within the scope of the invention, which is defined in the appended claims.

What is claimed is:

1. An image processing apparatus operable to communicate with a host device and to execute an input job input to the image processing apparatus, the image processing apparatus comprising:
a first input processor for obtaining a primary processing condition indicating how the input job is to be executed;
a second input processor for obtaining a job identification condition from the host device;
a decision unit for using the primary processing condition and the job identification condition to determine whether the job was input under a given condition;
a notifier for notifying the host device if the input job was input under the given condition;
a third input processor for obtaining a secondary processing condition output from the host device in reply to the notification from the notifier; and
an execution controller for executing the input job according to the primary processing condition and the secondary processing condition.

2. The image processing apparatus of claim 1, wherein the primary processing condition specifies at least one of scanning, printing, copying, facsimile transmission, and electronic mail transmission.

3. The image processing apparatus of claim 1, wherein the secondary processing condition specifies at least one of cancellation, suspension, resumption, obtaining a job log, obtaining job input information, performing additional printing, performing additional facsimile transmission, and performing additional electronic mail transmission.

4. The image processing apparatus of claim 1, wherein the execution controller begins executing the input job when the first input processor obtains the primary processing condition.

5. The image processing apparatus of claim 1, wherein the execution controller begins executing the input job when the second input processor obtains the secondary processing condition, after the first input processor has obtained the primary processing condition.

6. The image processing apparatus of claim 5, wherein the execution controller executes the input job according to the secondary processing condition before executing the input job according to the primary processing condition.

7. The image processing apparatus of claim 1, further comprising a memory unit for storing an existing job identification condition and modifying the existing job identification condition according to the job identification condition obtained by the second input processor.

8. The image processing apparatus of claim 1, further comprising a memory unit for storing an existing job identification condition and replacing the existing job identification condition with the job identification condition obtained by the second input processor.

9. A method of executing an input job input to an image processing apparatus that communicates with a host device, the method comprising:
obtaining a primary processing condition indicating how the input job is to be executed;
obtaining a job identification condition from the host device;
using the primary processing condition and the job identification condition to determine whether the job was input under a given condition;
notifying the host device if the input job was input under the given condition;
obtaining in reply a secondary processing condition output from the host device, if the input job was input under the given condition; and
executing the input job according to the primary processing condition and the secondary processing condition.

10. The method of claim 9, wherein the primary processing condition specifies at least one of scanning, printing, copying, facsimile transmission, and electronic mail transmission.

11. The method of claim 9, wherein the secondary processing condition specifies at least one of cancellation, suspension, resumption, obtaining a job log, obtaining job input information, performing additional printing, performing additional facsimile transmission, and performing additional electronic mail transmission.

12. The method of claim 9, wherein executing the input job begins when the primary processing condition is obtained.

13. The method of claim 9, wherein executing the input job begins when the secondary processing condition is obtained, after the primary processing condition has been obtained.

14. The method of claim 13, wherein the input job is executed according to the secondary processing condition before being executed according to the primary processing condition.

15. The method of claim 9, further comprising:
storing an existing job identification condition in a memory unit; and
modifying the existing job identification condition according to the job identification condition obtained in said obtaining the job identification condition.

16. The method of claim 9, further comprising:
storing an existing job identification condition in a memory unit; and
replacing the existing job identification condition with the job identification condition obtained in said obtaining the job identification condition.
